(19) United States
(12) Patent Application Publication
(10) Pub. No.: US 2025/0045136 A1
(43) Pub. Date: Feb. 6, 2025

(54) PERFORMANCE ANALYSIS OF JOBS IN COMPUTING CLUSTERS

(71) Applicant: Hewlett Packard Enterprise Development LP, Spring, TX (US)

(72) Inventors: Premnath Mangal, Bangalore (IN); Duncan Roweth, Bristol (GB); Nilakantan Mahadevan, Minneapolis, MN (US)

(21) Appl. No.: 18/491,845

(22) Filed: Oct. 23, 2023

(30) Foreign Application Priority Data
Jul. 31, 2023 (IN) 202311051319

(51) Int. Cl. G06F 11/07; G06F 11/34

(52) U.S. Cl. CPC G06F 11/0766; G06F 11/0709; G06F 11/0751; G06F 11/079; G06F 11/3409

(57) ABSTRACT

Example implementations relate to performance analysis of jobs in computing clusters. In some examples, a processor detects a trigger event in a computing cluster, and identifies a computing job associated with the trigger event. The processor determines a time window associated with trigger event, and determines compute nodes executing the computing job during the time window. The processor determines database attributes associated with the compute nodes, and obtains data values for the determined database attributes in the determined time window. The processor determines whether the data values are correlated to the trigger event base according to a diagnostic rule. In response to a determination that the data values are correlated to the trigger event base according to the diagnostic rule, the processor determines provides an indication of a degraded performance for the computing job.

### BRIEF DESCRIPTION OF THE DRAWINGS

Some implementations are described with respect to the following figures.

FIG. 1 is a schematic diagram of an example computing cluster, in accordance with some implementations.

FIG. 2 is a schematic diagram of an example compute node, in accordance with some implementations.

FIG. 3 is an illustration of example computing jobs, in accordance with some implementations.

FIG. 4 is an illustration of example mapping data, in accordance with some implementations.

FIG. 5 is an illustration of an example process, in accordance with some implementations.

FIGS. 6A-6D are illustrations of example operations, in accordance with some implementations.

FIG. 7 is a schematic diagram of an example computing device, in accordance with some implementations.

FIG. 8 is a diagram of an example machine-readable medium storing instructions in accordance with some implementations.

FIG. 9 is an illustration of an example process, in accordance with some implementations.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In some examples, a computing cluster may include a large number of components that generate telemetry data. Such components include compute nodes to execute computing jobs, network switches to interconnect components, storage nodes to persistently store data, power devices to provide electrical power to other components, cooling devices to address heat loads of other components, and so forth. In some examples, a computing job running on a computing cluster may suffer from a performance degradation. Such performance degradation of computing jobs may not be acceptable in a production environment. However, a management system of the cluster may lack functionality to rapidly and efficiently detect the performance degradation of an individual computing job that is executed across a relatively large number of compute nodes, and to determine the root cause(s) of such performance degradation. For example, some management systems may be configured to monitor and analyze data from a specific type of component (e.g., network devices, cooling devices, etc.), but not to correlate multiple types of telemetry generated across a large number of different nodes that execute a computing job. Accordingly, determining and troubleshooting the performance of individual computing jobs may require significant time and processing capacity, and may therefore result in reduced system performance and inefficient cluster management.

In accordance with some implementations of the present disclosure, the telemetry data from multiple components of a computing cluster may be stored in a time-series database. A controller may identify a computing job that may be impacted by a detected trigger event, and in response may identify a set of compute nodes executing the computing job. The controller may query the time-series database to obtain data values for a relevant time window, and may determine whether the data values are correlated to the trigger event according to a diagnostic rule. If it is determined that the data values are correlated to the trigger event, the controller may provide an alert indicating degraded performance for the computing job. Further, the controller may use the diagnostic rule to determine a probable root cause for the degraded performance of the computing job. In this manner, some implementations may provide functionality to rapidly and efficiently detect the performance degradation of an individual computing job that is executed across multiple compute nodes, and to determine the root cause of this performance degradation. Accordingly, some implementations may provide improved management system performance and efficient cluster management.

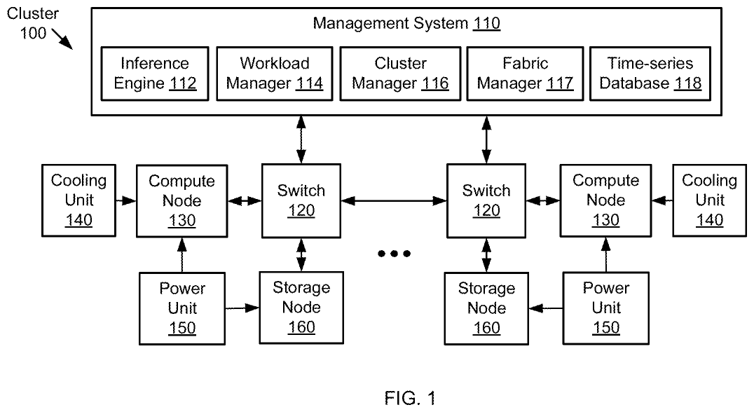

### FIG. 1—Example Computing Cluster

FIG. 1 shows an example of a computing cluster 100, in accordance with some implementations. The computing cluster 100 may include any number and type of cluster components coupled via network links. For example, as shown in FIG. 1, the computing cluster 100 may include network switches 120, storage nodes 160, compute nodes 130, cooling units 140, power units 150, and a management system 110.

In some implementations, the network switches 120 may be included a network fabric (also referred to as a “network”) that can allow the components of the computing cluster 100 to communicate with one another. Each network switch 120 may include a number of fabric ports to connect to other network switches 120. Further, each network switch 120 may include a number of edge ports to connect to non-switch cluster components (e.g., storage nodes 160, compute nodes 130, management system 110, etc.) over corresponding links. A “link” can refer to a communication medium (wired and/or wireless) over which devices can communicate with one another.

In some implementations, each storage node 160 may include or manage any number of storage components to persistently store data (e.g., a storage array, hard disk drives (HDDs), solid state drives (SSDs), optical disks, and so forth). Each cooling unit 140 may be a device to remove heat from one or more cluster components (e.g., network switches 120, storage nodes 160, compute nodes 130). For example, a cooling unit 140 may be a device including pumps and valves to distribute a coolant fluid to remove heat from a particular set of compute nodes 130. Further, each power unit 150 may be a power supply device to regulate and distribute electrical power to cluster components (e.g., a grouping of storage nodes 160 and compute nodes 130).

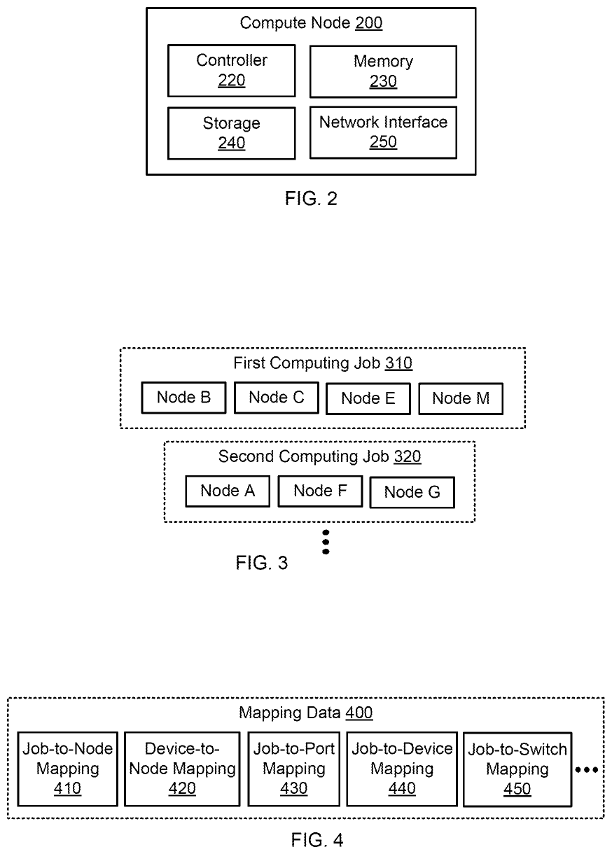

In some implementations, each compute node 130 may be a computing device (e.g., a server) that may read data from (and write data to) the storage nodes 160 via corresponding links. For example, each compute node 130 may be a computer server including a processor, memory, and persistent storage. An example implementation of a compute node 130 is described below with reference to FIG. 2. Further, in some implementations, a single computing job (e.g., a defined program or task) may be executed across multiple compute nodes 130 in distributed fashion. Example allocations of compute nodes to computing jobs are described below with reference to FIG. 3.

In some implementations, the management system 110 may include any number of management components. For example, the management system 110 may include or implement an inference engine 112, a workload manager 114, a cluster manager 116, a fabric manager 117, and a time-series database 118. The management components 112, 114, 116, 117, 118 may be implemented using machine-readable instructions executable on hardware processing circuitry of the management system 110. Although FIG. 1 shows an example in which the management components 112, 114, 116, 117, 118 are implemented in a single management system 110, in other examples, the management components 112, 114, 116, 117, 118 may be implemented in distinct devices or services.

In some implementations, the workload manager 114 may manage and schedule computing jobs on various sets of compute nodes 130. For example, the workload manager 114 may include or manage job-to-node mapping data that records relationships between computing jobs and compute nodes 130 (e.g., which compute nodes 130 are executing each computing job, which storage node 160 is storing data of each computing job, and so forth.

In some implementations, the cluster manager 116 may maintain mappings and other information for various components included in the computing cluster 100. For example, the cluster manager 116 may configure and manage device-to-node mapping data that records relationships between computing nodes 130 and associated devices (e.g., which cooling unit 140 is providing cooling for each compute node 130, which power units 150 is providing electrical power to each compute node 130 or storage node 160, and so forth). Further, the fabric manager 117 may configure and manage the topology and mapping information for network components included in the computing cluster 100 (e.g., which network switch 120 and edge port is connected to a compute node 130, which network switch 120 and edge port is connected to a storage node 160, which fabric ports are used by a link between a two network switches 120, and so forth).

In some implementations, the time-series database 118 may receive and store telemetry data generated by components of the computing cluster 100 (e.g., by network switches 120, storage nodes 160, compute nodes 130, power devices, cooling devices, and so forth). As used herein, the term “time-series database” may refer to a database that is specifically adapted for storing streams of time-stamped or time-series data. For example, the time-series database 118 may include (or may interface with) programming to extract telemetry data from received network messages, perform transformations on the telemetry data, and append the telemetry data to stored tables. As used herein, the term “telemetry data” may refer to transmitted data indicating a state or metric regarding a component. For example, telemetry data may include performance metrics, device events, software interrupts, alerts, temperature measurements, power consumption measurements, operating settings, error messages, network metrics, status reports, and so forth.

In some implementations, the time-series database 118 may store telemetry data using attributes and associated values. The attributes of the time-series database 118 may correspond to each type of telemetry data of the computing cluster 100, each component of the computing cluster 100, or any combination thereof. For example, the time-series database 118 may include a table composed of rows, where each row corresponds to a different received telemetry data element. Further, each row may include multiple columns, where each column represents a different attribute (i.e., parameter) of the telemetry data element. For example, each row may include a “Time” column (i.e., attribute) to record a creation time for the telemetry data element. Further, each row may include a column “Node ID” to store an identifier of the compute node 130 that generated the telemetry data element. Further, each row may include a column “Frequency” to store a value indicating the operating frequency (i.e., clock speed) of the compute node 130 (identified by the “Node ID” column) at the creation time for the telemetry data element (recorded in the “Time” column).

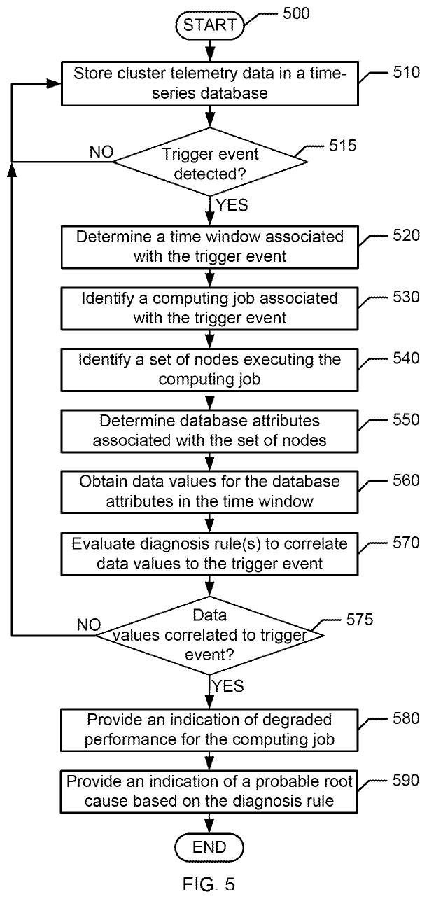

In some implementations, the inference engine 112 may detect trigger events in the computing cluster 100 (e.g., an interrupt, an error event, a crossed threshold of a performance metric, and so forth). In response to detecting the trigger event, the inference engine 112 may determine a time window associated with trigger event. The inference engine 112 may identify a computing job that may be impacted by the detected event. Further, the inference engine 112 may identify a set of compute nodes 130 that executed the computing job during the time window. The inference engine 112 may determine a set of database attributes associated with the set of compute nodes, and may query the time-series database 118 to obtain data values for the monitoring database attributes in the time window. The inference engine 112 may then determine whether the plurality of data values are correlated to the trigger event base according to a diagnostic rule. If so, the inference engine 112 may provide an alert indicating degraded performance for the computing job. The inference engine 112 may also provide an indication of the probable root cause for degraded performance based on the diagnostic rule. The functionality of the inference engine 112 is described further below with reference to FIGS. 5-9, in accordance with some implementations.

In some implementations, the inference engine 112 may be based on or include any type of machine logic or learning. For example, the inference engine 112 may include stored rules, expert system logic, neural networks, artificial intelligence (AI) large language models (LLMs), and so forth. In some implementations, the inference engine 112 may include or implement a set of diagnostic rules. Each diagnostic rule may identify or define a root cause for a performance degradation based on correlation(s) between data variables. For example, a diagnostic rule may specify that a trigger event (e.g., an interrupt) may be correlated to a telemetry data event (e.g., a specified percentage drop in a performance metric). The diagnostic rule may specify that a performance degradation has occurred if the trigger event is determined to correlated to the telemetry data event (e.g., if both occur in the same time period). Further, the diagnostic rule may also specify a probable root cause for this degraded performance. In some implementations, the inference engine 112 may use various types of mapping data to detect and diagnose degraded performance for computing jobs. An example implementation of mapping data used by the inference engine 112 is described below with reference to FIG. 4.

### FIG. 2—Example Compute Node

FIG. 2 shows an example compute node 200, in accordance with some implementations. The compute node 200 may correspond generally to an example implementation of the compute node 130 (shown in FIG. 1). As shown, the compute node 200 may include a controller 220, a memory device 230, a storage device 240, and a network interface 240. The controller 220 may include a hardware processing circuit, which can include any or some combination of a microprocessor, a core of a multi-core microprocessor, a microcontroller, a graphics processing unit (GPU), a programmable integrated circuit, a programmable gate array, a digital signal processor, or another hardware processing circuit. Further, the controller 220 may include a combination of a hardware processing circuit and machine-readable instructions (software and/or firmware) executable on the hardware processing circuit. The storage device 240 may include one or more non-transitory storage media such as hard disk drives (HDDs), solid state drives (SSDs), optical disks, and so forth, or a combination thereof. The memory device 230 may be implemented in semiconductor memory such as random access memory (RAM). The network interface 240 may include a network interface controller (NIC) to allow the compute node 200 to communicate over the network. Note that, although not shown in FIG. 2, the example compute node 200 may include other node components.

### FIG. 3—Example Computing Jobs

FIG. 3 shows example computing jobs, in accordance with some implementations. In some implementations, a single computing job (e.g., a defined program or task) may be allocated or assigned to multiple compute nodes, and may be executed across the allocated compute nodes in distributed fashion. For example, a first computing job 310 may be executed across four compute nodes B, C, E, and M. In another example, a second computing job 320 may be executed across three compute nodes A, F, and G. Further, although not shown in FIG. 3, it is contemplated that the compute nodes may be allocated to different computing jobs at different points in time. For example, after completion of the second computing job 320, the compute nodes A, F, and G may be reallocated to other computing job(s) (not shown in FIG. 3). Other examples are possible. In some implementations, each of the compute nodes A, B, C, E, F, G and M may correspond generally to the compute node 130 (shown in FIG. 1).

### FIG. 4—Example Mapping Data

FIG. 4 shows an example set of mapping data 400, in accordance with some implementations. The mapping data 400 may be used by a controller or engine (e.g., inference engine 112 shown in FIG. 1) to detect and diagnose degraded performance for computing jobs. The mapping data 400 may include job-to-node mapping data 410, device-to-node mapping data 420, job-to-port mapping data 430, job-to-device mapping data 440, job-to-switch mapping data 450, and so forth. In some implementations, different portions of the mapping data 400 may be included in various components of the management system 110 or the computing cluster 100 (shown in FIG. 1). For example, the job-to-node mapping data 410 may be included in (or managed by) the workload manager 114. In another example, the device-to-node mapping data 420 may be included in (or managed by) the cluster manager 116. In yet another example, the job-to-switch mapping data 450 may be included in (or managed by) the fabric manager 117. Other implementations are possible.

### FIG. 5—Example Process

FIG. 5 shows an example process 500 for analyzing performance of computing jobs in a computing cluster, in accordance with some implementations. In some examples, the process 500 may be performed using the inference engine 112 (shown in FIG. 1). The process 500 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth. For the sake of illustration, details of the process 500 may be described below with reference to FIGS. 1-4, which show examples in accordance with some implementations. However, other implementations are also possible.

Block 510 may include storing cluster telemetry data in a time-series database (e.g., time-series database 118 shown in FIG. 1). Decision block 515 may include determining whether a trigger event has been detected. Upon a negative determination (“NO”), the process 500 may return to block 510 (e.g., to continue storing cluster telemetry data in the time-series database).

Otherwise, if it is determined at decision block 515 that a trigger event has been detected (“YES”), the process 500 may continue at block 520, including determining a time window associated with the trigger event. For example, referring to FIG. 1, upon determining that a trigger event has been detected, the inference engine 112 may identify a time window that begins at a defined time period (e.g., five seconds) before the occurrence of the trigger event. Further, the inference engine 112 may identify the time window that ends at another time period after the occurrence of the trigger event.

Block 530 may include identifying a computing job associated with the trigger event. Block 540 may include identifying a set of nodes executing the computing job. Block 550 may include determining database attributes associated with the set of nodes. Block 560 may include obtain data values for the database attributes in the time window. For example, referring to FIGS. 1-4, upon determining that a detected trigger event is a failure alert for a particular cooling unit 140, the inference engine 112 uses the job-to-device mapping data 440 to identify a computing job that is mapped to that particular cooling unit 140. Further, the inference engine 112 uses the job-to-node mapping data 410 to identify a set of compute nodes 130 executing the identified computing job. The inference engine 112 uses the time-series database 118 or other mapping data 400 to identify database attributes that are associated with the set of compute nodes 130 or the cooling unit 140 (e.g., types of node metrics, types of node alerts, types of device interrupts, and so forth). The inference engine 112 then queries the time-series database 118 to obtain a set of data values associated with the database attributes and corresponding to the time window.

Block 570 may include evaluate diagnosis rule(s) to correlate the obtained data values to the trigger event. Decision block 575 may include determining whether the obtained data values are correlated to the trigger event according to the diagnostic rule. Upon a negative determination (“NO”), the process 500 may return to block 510. Otherwise, upon a positive determination (“YES”), the process 500 may continue at block 580, including providing an indication of degraded performance for the computing job. Block 590 may include providing an indication of a probable root cause based on the diagnosis rule. After block 590, the process 500 may be completed. For example, referring to FIGS. 1-4, the inference engine 112 determines that the obtained data values indicate a drop in performance of a compute node 130 (e.g., a reduction in clock speed). Further, based on a diagnostic rule associated with a failure alert for a cooling unit 140 (i.e., the detected trigger event), the inference engine 112 determines that the drop in node performance is a possible result of a failure of a cooling unit 140. As such, the inference engine 112 determines that the drop in node performance is correlated to the detected trigger event (i.e., a failure alert for a cooling unit 140). Therefore, the inference engine 112 generates an alert to indicate that the computing job has suffered degraded performance, and that the probable root cause is the failed cooling unit 140.

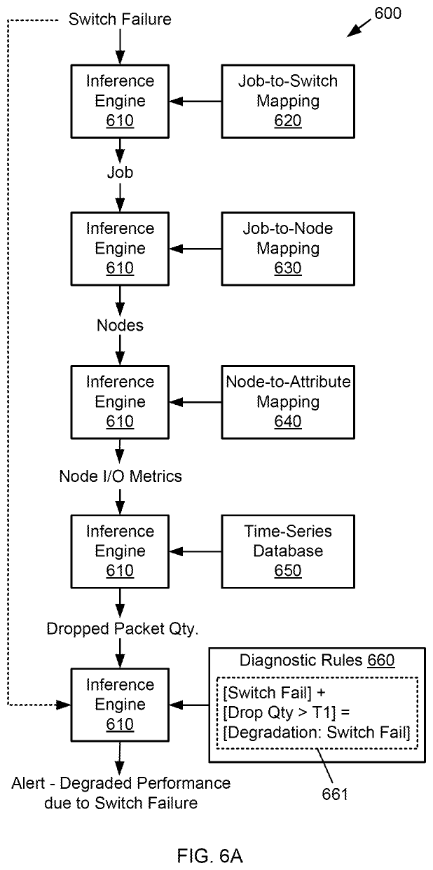

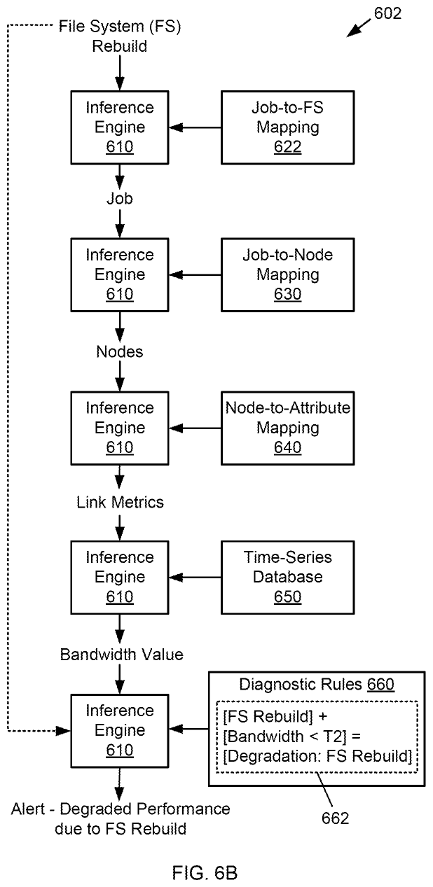

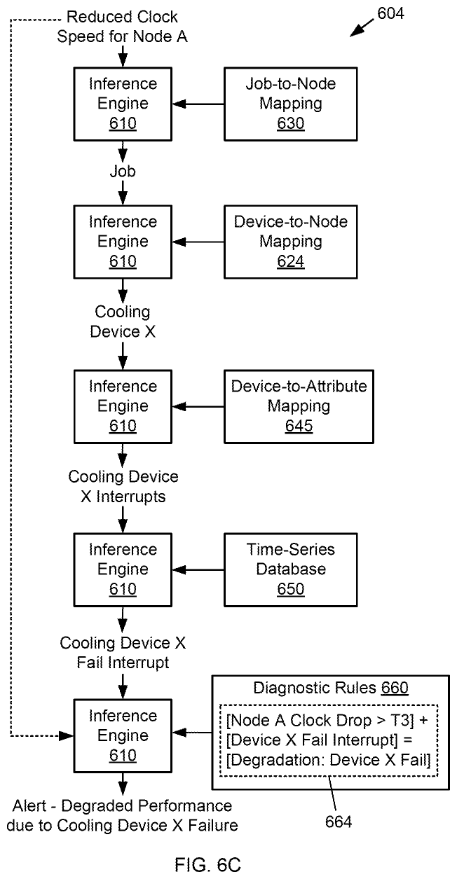

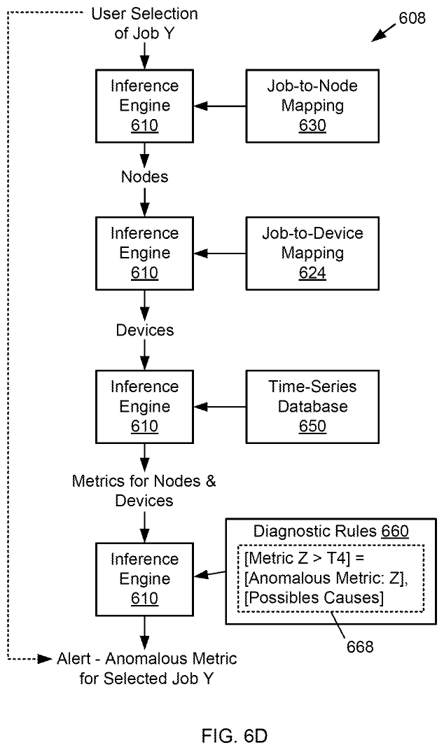

### FIGS. 6A-6D—Example Operations

FIG. 6A shows a first example operation 600 for identifying and diagnosing degraded performance for computing jobs of a computing cluster (e.g., cluster 100 shown in FIG. 1). As shown, an inference engine 610 may detect a network switch failure (e.g., a trigger event), and in response may use a job-to-switch mapping 620 to identify a computing job that is associated with the failed switch. The inference engine 610 may use a job-to-node mapping 630 to identify a set of compute nodes that execute the computing job during a time window associated with the network switch failure (e.g., a defined time period preceding or overlapping the detection of the network switch failure).

The inference engine 610 may then use a node-to-attribute mapping 640 to identify a set of node input/output (I/O) metrics (e.g., database attributes) that are associated with the set of compute nodes. For example, the node I/O metrics may include a “dropped packet” metric that measures the number of packets that are dropped in a network link of a compute node. The inference engine 610 may then query a time-series database 650 to obtain a set of data values for the database attributes in the time window (e.g., the quantity of packets dropped per second during the time window). The inference engine 610 may determine that the number of dropped packets increased during the time window. Further, the inference engine 610 may perform a look-up in a set of diagnostic rules 660 (e.g., based on the switch failure and/or the dropped packet metric). The inference engine 610 may identify a diagnostic rule 661 indicating that the computing job has suffered a degraded performance if a detected switch failure is correlated to an increase in the number of dropped packets above a first threshold T1 (e.g., have both occurred with a time window). Further, the diagnostic rule 661 may indicate that the probable root cause of the degraded performance is the switch failure. Accordingly, the inference engine 610 may generate an alert to indicate that the performance of the computing job was degraded, and that the probable root cause for this degraded performance is the failed network switch.

Referring now to FIG. 6B, shown is a second example operation 602. As shown, the inference engine 610 may detect a file system (FS) rebuild event (e.g., indicating that a particular file system is being regenerated on a storage node 160). In response to detecting this trigger event, the inference engine 610 may use a job-to-FS mapping 622 to identify a computing job using that particular file system. The inference engine 610 may use a job-to-node mapping 630 to identify a set of compute nodes that executed the computing job during a time window associated with the FS rebuild event.

The inference engine 610 may then use a node-to-attribute mapping 640 to identify a set of link metrics (e.g., database attributes) that are associated with network links for the set of compute nodes. For example, the network metrics may include a “Link Bandwidth” metric that measures the amount of data being transmitted across a network link between a storage node and a compute node. The inference engine 610 may then query a time-series database 650 to obtain bandwidth value for the time window. The inference engine 610 may determine that the bandwidth value decreased during the time window. Further, the inference engine 610 may perform a look-up in a set of diagnostic rules 660 (e.g., based on the FS rebuild event and/or the “Link Bandwidth” metric). The inference engine 610 may identify a diagnostic rule 662 indicating that the computing job has suffered a degraded performance if a detected FS rebuild event is correlated with a decrease in the bandwidth value below a second threshold T2. Further, the diagnostic rule 662 may indicate that the probable root cause of the degraded performance is the FS rebuild event. Accordingly, the inference engine 610 may generate an alert to indicate that the performance of the computing job was degraded, and that the probable root cause for this degraded performance is the failed FS rebuild event.

Referring now to FIG. 6C, shown is a third example operation 604. As shown, the inference engine 610 may detect a reduced clock speed for a particular compute node A. In response to detecting this trigger event, the inference engine 610 may use a job-to-node mapping 630 to identify a particular computing job that is executed by the compute node A during a time window associated with the trigger event. The inference engine 610 may use a device-to-node mapping 624 to identify a cooling device “X” that provides cooling for the compute node “A” during the time window.

The inference engine 610 may then use a device-to-attribute mapping 645 to identify a set of device interrupts (e.g., database attributes) that are associated with the cooling device X. For example, the device interrupts may indicate various errors or failures in the cooling device X. The inference engine 610 may then query a time-series database 650 to obtain a failure interrupt value indicating that a hardware failure occurred in the cooling device X. The inference engine 610 may perform a look-up in a set of diagnostic rules 660 (e.g., based on the reduced clock speed metric and/or the failure interrupt). The inference engine 610 may identify a diagnostic rule 664 indicating that the computing job has suffered a degraded performance if a reduced clock speed for compute node A (e.g., below threshold T3) is correlated with a failure interrupt for the cooling device X. Further, the diagnostic rule 664 may indicate that the probable root cause of the degraded performance is the failure in the cooling device X. Accordingly, the inference engine 610 may generate an alert to indicate that the performance of the computing job was degraded, and that the probable root cause for this degraded performance is the failed cooling device X.

Referring now to FIG. 6D, shown is a fourth example operation 608. As shown, the inference engine 610 may detect a user selection of a particular computing job (e.g., a trigger event). In response to detecting this trigger event, the inference engine 610 may use a job-to-node mapping 630 to identify a set of compute nodes that execute the selected computing job during a defined time window.

The inference engine 610 may then use a job-to-device mapping 624 to identify a set of devices that are associated with the set of compute nodes. The inference engine 610 may query the time-series database 650 to identify a set of metrics that are associated with the set of compute nodes and the set of devices, and to obtain the metric values that correspond to the time window. The inference engine 610 may use the diagnostic rules 660 to analyze the metric values, and to determine whether any of the metric values are anomalous. In some implementations, at least some diagnostic rules 660 may each specify the normal operating ranges for different metrics. The inference engine 610 may use the diagnostic rules 660 to compare each metric value to a normal operating range for that metric value, and may flag a metric value that falls outside its normal operating range. For example, as shown in FIG. 6D, the inference engine 610 uses a diagnostic rule 668 to determine that the metric Z values exceed a threshold T4, and therefore the current metric Z values fall outside the normal operating range for metric Z. Further, in some implementations, the diagnostic rule 668 may specify one or more possible root causes that may result in metric Z being diagnostic rule 668. The inference engine 610 may generate an alert to indicate that metric Z is currently anomalous, and to identify the probable root causes for the anomalous metric Z.

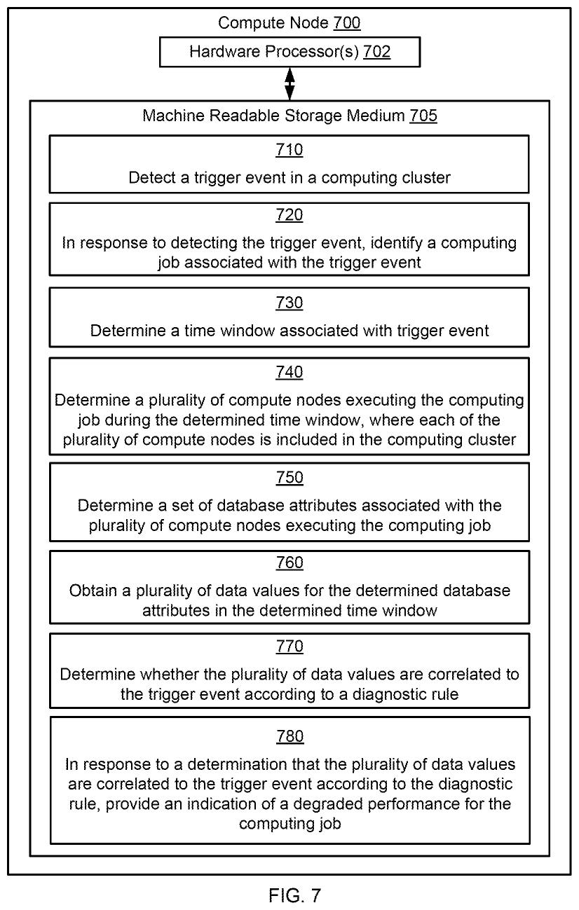

### FIG. 7—Example Computing Device

FIG. 7 shows a schematic diagram of an example computing device 700. In some examples, the computing device 700 may correspond generally to some or all of the management system 110 (shown in FIG. 1A). As shown, the computing device 700 may include hardware processor 702 and machine-readable storage 705 including instructions 710-780. The machine-readable storage 705 may be a non-transitory medium. The instructions 710-780 may be executed by the hardware processor 702, or by a processing engine included in hardware processor 702.

Instruction 710 may be executed to detect a trigger event in a computing cluster. As used herein, “detect a trigger event” may refer to detecting an event that may indicate or cause a possible degradation of performance for a computing job executed by a computing cluster. For example, referring to FIG. 1, the inference engine 112 may detect that trigger events have occurred in the computing cluster 100 (e.g., an interrupt, an error event, a crossed threshold of a performance metric, etc.).

Instruction 720 may be executed to, in response to detecting the trigger event, identify a computing job associated with the trigger event. As used herein, “identify a computing job associated with the trigger event” may refer to identifying a computing job that may suffer a degradation of performance indicated or caused by the trigger event. For example, referring to FIGS. 1-4, in response to detecting the trigger event, the inference engine 112 may determine that a detected trigger event is a failure alert for a particular cooling unit 140, and may read the job-to-device mapping data 440 to identify a computing job that is mapped to that particular cooling unit 140. Otherwise, if the inference engine 112 does not detect a trigger event, the inference engine 112 does not perform any action.

Instruction 730 may be executed to determine a time window associated with trigger event. As used herein, “determine a time window associated with trigger event” may refer to identifying a time range that corresponds to the time of occurrence of the trigger event, and which may include events or data correlated to the trigger event. For example, referring to FIG. 1, upon determining that a trigger event has been detected, the inference engine 112 may identify a time window that begins at a defined time period (e.g., five seconds) before the occurrence of the trigger event. Further, the inference engine 112 may identify the time window that ends at another time period after the occurrence of the trigger event.

Instruction 740 may be executed to determine a plurality of compute nodes executing the computing job during the determined time window, where each of the plurality of compute nodes is included in the computing cluster. As used herein, “determine a plurality of compute nodes executing the computing job during the determined time window” may refer to identifying a set of compute nodes that are allocated to execute the identified computing job during the determined time window. For example, referring to FIGS. 1-4, the inference engine 112 may perform a look-up of the first computing job 310 in the job-to-node mapping data 410, and may thereby determine that the compute nodes B, C, E, and M are allocated to execute the first computing job 310 during the time window.

Instruction 750 may be executed to determine a set of database attributes associated with the plurality of compute nodes executing the computing job. As used herein, “determine a set of database attributes associated with the plurality of compute nodes” may refer to identifying a set of database attributes for telemetry data that indicates characteristics or events of the compute nodes. For example, referring to FIGS. 1-4, the inference engine 112 may read the mapping data 400 to identify database attributes of the time-series database 118 that correspond to characteristics or events of the set of compute nodes (e.g., types of node metrics, types of node alerts, etc.).

Instruction 760 may be executed to obtain a plurality of data values for the determined database attributes in the determined time window. As used herein, “obtain a plurality of data values for the determined database attributes in the determined time window” may refer to querying a database to read stored data values that correspond to the determined set of database attributes, and which match the time window. For example, referring to FIG. 1, the inference engine 112 may query the time-series database 118 to obtain a set of data values associated with the database attributes and corresponding to the time window.

Instruction 770 may be executed to determine whether the plurality of data values are correlated to the trigger event according to a diagnostic rule. Instruction 780 may be executed to, in response to a determination that the plurality of data values are correlated to the trigger event according to the diagnostic rule, provide an indication of a degraded performance for the computing job. As used herein, “determine whether the plurality of data values are correlated to the trigger event according to a diagnostic rule” may refer to determining whether a diagnostic rule specifies a correlation between a set of data values and the trigger event. Further, as used herein, “provide an indication of a degraded performance for the computing job” may refer to generating a notification to indicate that the computing job has suffered a degraded performance. For example, referring to FIG. 6A, the inference engine 610 may perform a look-up in a set of diagnostic rules 660 (e.g., based on the switch failure and/or the dropped packet metric). Further, the inference engine 610 may identify a diagnostic rule 661 indicating that the computing job has suffered a degraded performance if a detected switch failure is correlated to an increase in the number of dropped packets above a first threshold T1 (e.g., have both occurred with the time window). Accordingly, the inference engine 610 may generate an alert to indicate that the performance of the computing job was degraded. Otherwise, if the inference engine 112 does not determine that the plurality of data values are correlated to the trigger event according to a diagnostic rule, the inference engine 112 does not perform any action.

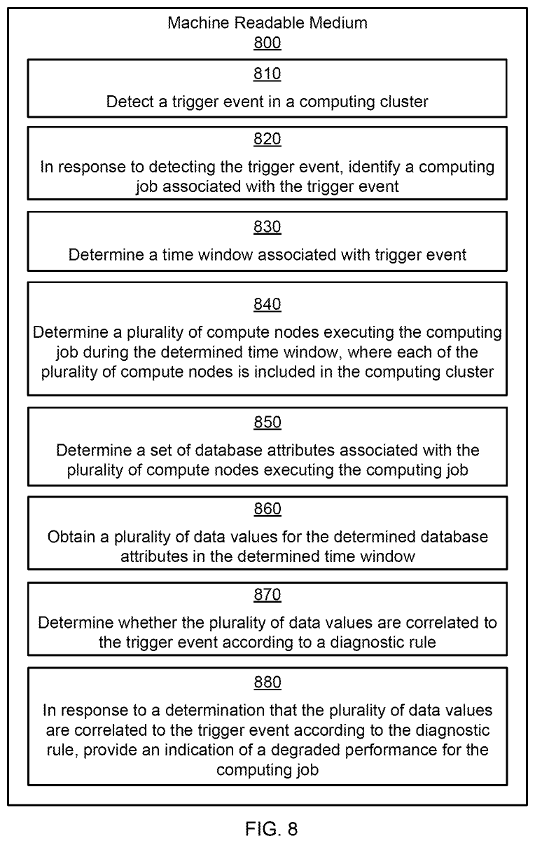

### FIG. 8—Example Machine-Readable Medium

FIG. 8 shows a machine-readable medium 800 storing instructions 810-880, in accordance with some implementations. The instructions 810-880 can be executed by a single processor, multiple processors, a single processing engine, multiple processing engines, and so forth. The machine-readable medium 800 may be a non-transitory storage medium, such as an optical, semiconductor, or magnetic storage medium. The instructions 810-880 may correspond generally to the examples described above with reference to instructions 710-780 (shown in FIG. 7).

Instruction 810 may be executed to detect a trigger event in a computing cluster. Instruction 820 may be executed to, in response to detecting the trigger event, identify a computing job associated with the trigger event. Instruction 830 may be executed to determine a time window associated with trigger event. Instruction 840 may be executed to determine a plurality of compute nodes executing the computing job during the determined time window, where each of the plurality of compute nodes is included in the computing cluster.

Instruction 850 may be executed to determine a set of database attributes associated with the plurality of compute nodes executing the computing job. Instruction 860 may be executed to obtain a plurality of data values for the determined database attributes in the determined time window. Instruction 870 may be executed to determine whether the plurality of data values are correlated to the trigger event according to a diagnostic rule. Instruction 880 may be executed to, in response to a determination that the plurality of data values are correlated to the trigger event according to the diagnostic rule, provide an indication of a degraded performance for the computing job.

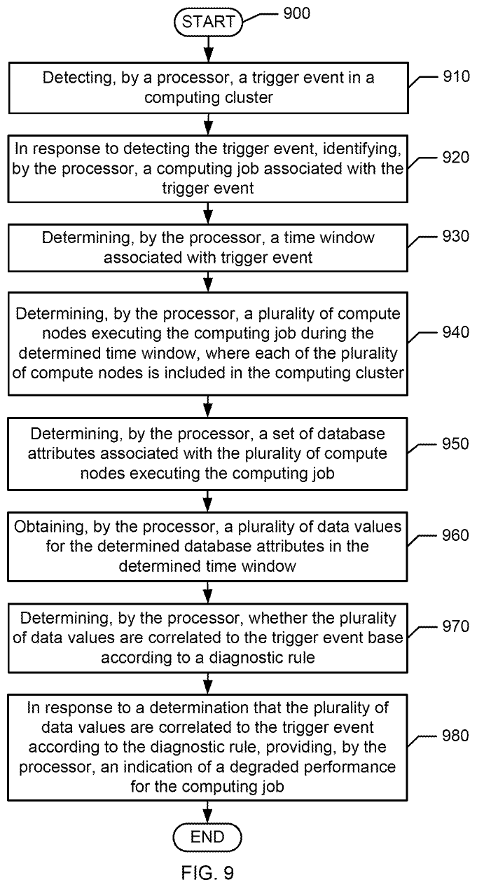

### FIG. 9—Example Process

FIG. 9 shows an example process 900, in accordance with some implementations. In some examples, the process 900 may be performed using a controller of the management system 110 (shown in FIG. 1). The process 900 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth. However, other implementations are also possible.

Block 910 may include detecting, by a processor, a trigger event in a computing cluster. Block 920 may include, in response to detecting the trigger event, identifying, by the processor, a computing job associated with the trigger event. Block 930 may include determining, by the processor, a time window associated with trigger event.

Block 940 may include determining, by the processor, a plurality of compute nodes executing the computing job during the determined time window, where each of the plurality of compute nodes is included in the computing cluster. Block 950 may include determining, by the processor, a set of database attributes associated with the plurality of compute nodes executing the computing job. Block 960 may include obtaining, by the processor, a plurality of data values for the determined database attributes in the determined time window.

Block 970 may include determining, by the processor, whether the plurality of data values are correlated to the trigger event base according to a diagnostic rule. Block 980 may include, in response to a determination that the plurality of data values are correlated to the trigger event according to the diagnostic rule, providing, by the processor, an indication of a degraded performance for the computing job. Blocks 910-980 may correspond generally to the examples described above with reference to instructions 710-780 (shown in FIG. 7).

In accordance with some implementations described herein, a controller may identify a computing job that may be impacted by a detected trigger event, and in response may identify a set of compute nodes executing the computing job. The controller may query the time-series database to obtain data values for a relevant time window, and may determine whether the data values are correlated to the trigger event based according to a diagnostic rule. If it is determined that the data values are correlated to the trigger event, the controller may provide an alert indicating degraded performance for the computing job. Further, the controller may use the diagnostic rule to determine a probable root cause for the degraded performance of the computing job. In this manner, some implementations may allow efficient analysis and troubleshooting of computing jobs executed by a computing cluster.

Note that, while FIGS. 1-9 show various examples, implementations are not limited in this regard. For example, referring to FIG. 1, it is contemplated that the computing cluster 100 may include additional devices and/or components, fewer components, different components, different arrangements, and so forth. In another example, it is contemplated that the functionality of the inference engine 112 described above may be included in any another engine or software of the management system 110. Other combinations and/or variations are also possible.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

What is claimed is:

1. A computing device comprising:
a memory; and
a processor configured to:
detect a trigger event in a computing cluster;
in response to detecting the trigger event, identify a computing job associated with the trigger event;
determine a time window associated with trigger event;
determine a plurality of compute nodes executing the computing job during the determined time window, wherein each of the plurality of compute nodes is included in the computing cluster;
determine a set of database attributes associated with the plurality of compute nodes executing the computing job;
obtain a plurality of data values for the determined database attributes in the determined time window;
determine whether the plurality of data values are correlated to the trigger event according to a diagnostic rule; and
in response to a determination that the plurality of data values are correlated to the trigger event according to the diagnostic rule, provide an indication of a degraded performance for the computing job.

2. The computing device of claim 1, the processor configured to:
provide an indication of a probable root cause for the degraded performance.

3. The computing device of claim 2, wherein the diagnostic rule specifies that the degraded performance has occurred if the trigger event is correlated to the plurality of data values, and wherein the diagnostic rule identifies probable root cause for the degraded performance.

4. The computing device of claim 1, the processor configured to:
perform a look-up of the computing job in a job-to-node mapping structure; and
determine the plurality of compute nodes based on the look-up of the computing job in the job-to-node mapping structure.

5. The computing device of claim 1, the processor configured to:
perform a look-up of the plurality of compute nodes in a node-to-attribute mapping structure; and
determine the set of database attributes based on the look-up of the plurality of compute nodes in the node-to-attribute mapping structure.

6. The computing device of claim 1, wherein the trigger event comprises one of:
a device event,
a network event,
a thermal event, and
an anomalous metric value.

7. The computing device of claim 1, the processor configured to:
store, in a time-series database, telemetry data received from components of the computing cluster, wherein the telemetry data comprises performance metrics and event data, and wherein the telemetry data is stored as time-series data values based on a plurality of database attributes.

8. The computing device of claim 7, wherein:
the telemetry data comprises storage node data, network device data, cooling device data, and power device data;
the storage node data comprises performance metrics and event data for a plurality of storage nodes included in the computing cluster;
the network device data comprises performance metrics and event data for a plurality of network devices included in the computing cluster;
the cooling device data comprises performance metrics and event data for a plurality of cooling devices included in the computing cluster; and
the power device data comprises performance metrics and event data for a plurality of power supply devices included in the computing cluster.

9. A method comprising:
detecting, by a processor, a trigger event in a computing cluster;
in response to detecting the trigger event, identifying, by the processor, a computing job associated with the trigger event;
determining, by the processor, a time window associated with trigger event;
determining, by the processor, a plurality of compute nodes executing the computing job during the determined time window, wherein each of the plurality of compute nodes is included in the computing cluster;
determining, by the processor, a set of database attributes associated with the plurality of compute nodes executing the computing job;
obtaining, by the processor, a plurality of data values for the determined database attributes in the determined time window;
determining, by the processor, whether the plurality of data values are correlated to the trigger event base according to a diagnostic rule; and
in response to a determination that the plurality of data values are correlated to the trigger event according to the diagnostic rule, providing, by the processor, an indication of a degraded performance for the computing job.

10. The method of claim 9, comprising:
providing an indication of a probable root cause for the degraded performance.

11. The method of claim 10, wherein the diagnostic rule specifies that the degraded performance has occurred if the trigger event is correlated to the plurality of data values, and wherein the diagnostic rule identifies probable root cause for the degraded performance.

12. The method of claim 9, wherein the diagnostic rule specifies that the degraded performance is associated with a correlation between a switch failure and an increase in a number of dropped packets.

13. The method of claim 9, wherein the diagnostic rule specifies that the degraded performance is associated with a correlation between a filesystem rebuild event and a decrease in a bandwidth value.

14. The method of claim 9, wherein the diagnostic rule specifies that the degraded performance is associated with a correlation between a reduced clock speed for a compute node and a failure of a cooling device.

15. A non-transitory machine-readable medium storing instructions that upon execution cause a processor to:
detect a trigger event in a computing cluster;
in response to detecting the trigger event, identify a computing job associated with the trigger event;
determine a time window associated with trigger event;
determine a plurality of compute nodes executing the computing job during the determined time window, wherein each of the plurality of compute nodes is included in the computing cluster;
determine a set of database attributes associated with the plurality of compute nodes executing the computing job;
obtain a plurality of data values for the determined database attributes in the determined time window;
determine whether the plurality of data values are correlated to the trigger event according to a diagnostic rule; and
in response to a determination that the plurality of data values are correlated to the trigger event according to the diagnostic rule, provide an indication of a degraded performance for the computing job.

16. The non-transitory machine-readable medium of claim 15, including instructions that upon execution cause the processor to:
provide an indication of a probable root cause for the degraded performance.

17. The non-transitory machine-readable medium of claim 16, wherein the diagnostic rule specifies that the degraded performance has occurred if the trigger event is correlated to the plurality of data values, and wherein the diagnostic rule identifies probable root cause for the degraded performance.

18. The non-transitory machine-readable medium of claim 15, including instructions that upon execution cause the processor to:
perform a look-up of the computing job in a job-to-node mapping structure; and
determine the plurality of compute nodes based on the look-up of the computing job in the job-to-node mapping structure.

19. The non-transitory machine-readable medium of claim 15, including instructions that upon execution cause the processor to:
perform a look-up of the plurality of compute nodes in a node-to-attribute mapping structure; and
determine the set of database attributes based on the look-up of the plurality of compute nodes in the node-to-attribute mapping structure.

20. The non-transitory machine-readable medium of claim 15, including instructions that upon execution cause the processor to:
store, in a time-series database, telemetry data received from components of the computing cluster, wherein the telemetry data comprises performance metrics and event data, and wherein the telemetry data is stored as time-series data values based on a plurality of database attributes.
